(19) United States
(12) Patent Application Publication
(10) Pub. No.: US 2010/0023746 A1
(43) Pub. Date: Jan. 28, 2010

(54) INFORMATION PROCESSING SYSTEM, INFORMATION PROCESSING APPARATUS, AND INFORMATION PROCESSING METHOD

(75) Inventor: Yoshiharu Imamoto, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 11/937,838

(22) Filed: Nov. 9, 2007

(30) Foreign Application Priority Data
Nov. 29, 2006 (JP) 2006-322521
Oct. 2, 2007 (JP) 2007-259236

(51) Int. Cl. H04L 9/00; G06F 3/14; G06F 12/14

(52) U.S. Cl. 713/150; 715/243

(57) ABSTRACT

This invention prevents confidential information included in information contents from leaking from an external apparatus when the external apparatus executes a layout process and print process of the information contents. An information processing system of this invention includes an information contents converter (101) which generates output information contents (107) and layout information contents (108), an access controller (104) which encrypts the output information contents (107) to generate encrypted output information contents (110), a layout data generator (102) which lays out the layout information contents (108) to generate layout data (109), and an output data embedding unit (103) which decrypts the encrypted output information contents (110) and generates output contents data (111) based on the layout data (109).

### BACKGROUND OF THE INVENTION

1. Field of the Invention

The present invention relates to an information processing technique for laying out a plurality of data included in information contents, and visually outputting the laid-out data.

2. Description of the Related Art

Direct mails, service usage bills, and the like are individually customized printed materials. Each of these printed materials is obtained by appropriately laying out and printing out information contents configured by fixed part data common to respective pages and variable part data different for respective pages.

The fixed part includes, for example, the logo of a billing company common to respective pages, messages for all customers, and the like. The variable part includes individual addresses and names different for respective pages, and messages, images, and the like only for a given person.

A print process that appropriately lays out information contents configured by the fixed and variable part data and printing a plurality of copies is generally called a variable print process. As means for implementing such print process, an add-in print process, a print process using PPML (Personalized Printing Markup Language), and the like are known.

In general, the add-in print process is executed in the following sequence. Initially, a template is prepared by laying out fixed part data to be printed common to respective pages, and output contents data is generated by designating embedding of variable part data different for respective pages at desired positions of the prepared template. Then, upon printing, the variable part data are embedded in the template to transmit raster data different for respective pages to a printer, thus outputting a printed material.

On the other hand, the PPML is a page description language used in the variable print process, and the print process using this language is done in the following sequence. Initially, how to lay out, in a page, objects (data that configure information contents) as units of data that configure each page is described using the PPML. As an example of an object, image data such as a logo and the like, text data, or a page description language such as PostScript or the like that expresses text data, and the like is known. Upon printing using a printer, objects which configure each page undergo an RIP (Raster Image Processor) process, and the raster data that have undergone the RIP process are composited to configure that page, thus outputting a printed material.

The RIP process is a process for generating raster data (two-dimensional bitmap information) of a printed material to be output based on output contents data configured by text data to be printed, vector data represented by PostScript, image data, and the like.

Note that the PPML allows the user to designate to cache an object which is repetitively used over a plurality of pages in the form of, for example, raster data or the like. By re-using the cached object over a plurality of pages, these pages can be printed at high speed.

Upon outputting individually customized printed materials in large quantities, expensive software required to lay out data that configure information contents, and a special apparatus or equipment such as a printer required to execute high-speed print processes are required. For this reason, the actual layout process and print process for printed materials are often outsourced to outside contractors.

However, information contents including personal information and confidential information such as images and the like are data groups which must be strictly handled for companies. Upon outsourcing the processes of such information contents to outside contractors, it is important to prevent leakage of data which configure the information contents.

For this reason, a print processing system which can prevent leakage of personal information used to print direct mails has been proposed conventionally.

For example, in Japanese Patent Laid-Open No. 2003-196066, an apparatus on the outsourcer side encrypts information contents including personal information, and transmits the encrypted information contents to a print processing apparatus managed by a print contractor as an outsourcing destination. The print processing apparatus decrypts the encrypted information contents, and then prints the information contents. Furthermore, the information contents used in the print process are automatically erased inside the print processing apparatus after the print process. With this configuration, information contents including personal information and confidential information such as an image and the like are never exposed to an operator at the print contractor, and can be prevented from leaking.

In the commercial print contractor that makes outsourcing, a skilled person such as a designer or the like normally executes the layout process (preparation of a template in the variable print process) of data which configure information contents using dedicated software.

However, when information contents are transmitted to the outsourcing destination after they are fully encrypted, the print contractor as the outsourcing destination cannot freely handle data which configure the information contents. For this reason, the outsourcer side prepares a template, and the print processing apparatus managed by the print contractor as the outsourcing destination merely prints the information contents according to that template. That is, the layout process cannot be outsourced.

On the other hand, when the outsourcer side transfers information contents including personal information and confidential information such as an image and the like to a print contractor as an outsourcing destination, and asks for the layout process (or modification of the laid-out design), the information may leak due to illicitness of a designer.

As a method of solving such problem, an access control method that gives a decryption key only to a print contractor who is authorized to execute the layout process may be used.

However, even when such method is used, since the information contents are decrypted in the actual layout process, an operator at the print contractor can freely handle data that configure the information contents during the layout process. For this reason, if the operator at the print contractor misbehaves during the layout process, the information contents may leak.

In this way, upon outsourcing the layout process and print process of information contents, it is desirable to prevent personal information and confidential information included in the information contents from leaking even during the layout process.

### SUMMARY OF THE INVENTION

The present invention has been made in consideration of the aforementioned problems, and has as its object to prevent personal information included in information contents from leaking from an external apparatus upon execution of the layout process and print process of the information contents by the external apparatus.

As means for achieving the above object, an information processing system according to the present invention comprises the following arrangement. That is,

An information processing system which lays out data included in information contents and visually outputs the laid-out data by connecting a plurality of information processing apparatuses to be able to communicate with each other,

a first information processing apparatus comprising:

a conversion unit configured to convert the data to be laid out and visually output into information indicating an attribute of the data;

an encryption unit configured to encrypt the data to be laid out and visually output; and

a transmission unit configured to transmit the information to a second information processing apparatus, and to transmit the data encrypted by the encryption unit to a third information processing apparatus,

the second information processing apparatus comprises:

a generation unit configured to generate layout data used to lay out the data based on the information transmitted by the transmission unit in the first information transmission apparatus; and

a transmission unit configured to transmit the layout data generated by the generation unit to the third information processing apparatus, and

the third information processing apparatus comprises:

a decryption unit configured to decrypt the data transmitted by the transmission unit in the first information processing apparatus; and

an output unit configured to lay out the data decrypted by the decryption unit based on the layout data transmitted by the transmission unit in the second information processing apparatus, and to visually output the laid-out data.

According to the present invention with the above arrangement, upon execution of the layout process and print process of information contents by an external apparatus, personal information included in the information contents can be prevented from leaking from the external apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of the functional arrangement of an information processing system according to one embodiment of the present invention;

FIG. 2 is a block diagram showing the hardware arrangement of an information processing apparatus used to implement the functions on the outsourcer side in the information processing system shown in FIG. 1;

FIG. 3 shows an example of information contents 106;

FIG. 4A shows an example of output information contents 107 generated based on the information contents 106 shown in FIG. 3;

FIG. 4B shows an example of layout information contents 108 generated by information contents converter 101 based on the information contents 106 shown in FIG. 3;

FIG. 5 shows an example of layout data 109;

FIG. 6 shows an example of output contents 112 generated using the information contents 106 shown in FIG. 3;

FIG. 7 is a block diagram showing the internal arrangement of the information contents converter 101;

FIG. 8 is a flowchart showing the sequence of layout information contents generation process of the information contents conversion process in the information contents converter 101;

FIG. 9 is a block diagram showing the internal arrangement of an access controller 104;

FIG. 10 is a block diagram showing the internal arrangement of a layout data generator 102;

FIG. 11 is a block diagram showing the internal arrangement of an output data embedding unit 103;

FIG. 12A is a block diagram showing an example of the arrangement of an information processing system when an outsourcer outsources the layout process and print process to a layout contractor and print contractor as outsourcing destinations, respectively;

FIG. 12B is a flowchart showing the sequence of the process in the information processing system shown in FIG. 12A;

FIG. 13A is a block diagram showing an example of the arrangement of an information processing system when an outsourcer outsources the layout process and print process to a print contractor as an outsourcing destination;

FIG. 13B is a flowchart showing the sequence of the process in the information processing system shown in FIG. 13A; and

FIG. 14 shows an example of a template.

### DESCRIPTION OF THE EMBODIMENTS

Preferred embodiments of the present invention will now be described in detail in accordance with the accompanying drawings.

### First Embodiment

### 1. Functional Arrangement of Information Processing System

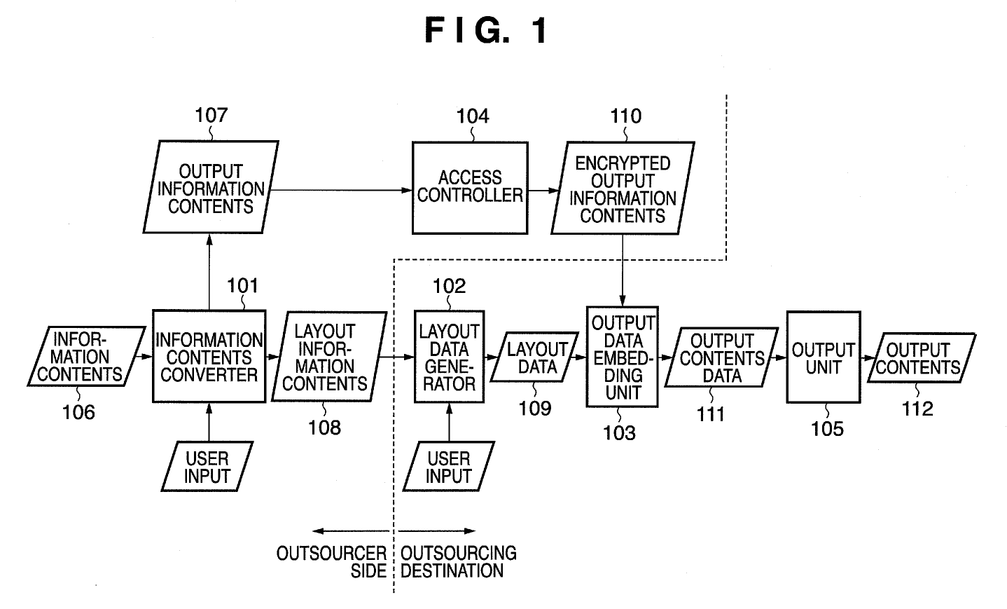

FIG. 1 shows an example of the functional arrangement of an information processing system according to this embodiment. As shown in FIG. 1, the information processing system according to this embodiment is configured by functions on the outsourcer side and those of an outsourcing destination.

Of these functions, those of the outsourcer side are implemented by an information contents converter 101 and access controller 104.

The information contents converter 101 generates output information contents 107 (which will be described in detail later) and layout information contents 108 (which will also be described in detail later) from input information contents 106 based on a user's input.

The access controller 104 encrypts the generated output information contents 107 to generate encrypted output information contents 110 that only an authorized entity can access.

On the other hand, the functions of the outsourcing destination are implemented by a layout data generator 102, output data embedding unit 103, and output unit 105.

The layout data generator 102 generates layout data 109 (which will be described in detail later) from the layout information contents 108 based on a user's input.

The output data embedding unit 103 decrypts the encrypted output information contents 110 to generate the output information contents 107. The unit 103 lays out the generated output information contents 107 in accordance with layout information described in the layout data 109, thereby generating output contents data 111. Note that the output data embedding unit 103 is provided as, for example, a renderer such as a printer driver or the like.

The output unit 105 processes the output contents data 111, thus generating and outputting output contents 112. Note that the output unit 105 deletes the corresponding output contents data 111 after it outputs the output contents 112. The output unit 105 is implemented by, for example, a printer or display.

Note that the output data embedding unit 103 and output unit 105 desirably have a tamper resistance. This is to make it difficult to externally analyze and illicitly read out data to be processed by the output data embedding unit 103 and output unit 105, and also to make it difficult to alter the process in the output data embedding unit 103 and to execute any illicit process.

Also, it is desirable to protect data on a transmission path from the output data embedding unit 103 to the output unit 105 by an encryption technique or the like.

### 2. Hardware Arrangement of Information Processing Apparatus on Outsourcer Side

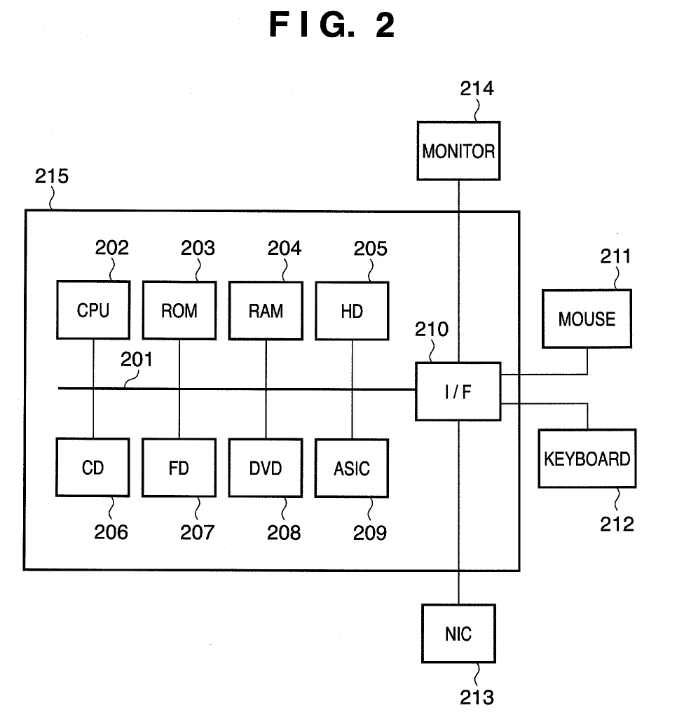

FIG. 2 shows the hardware arrangement of an information processing apparatus used to implement the functions on the outsourcer side shown in the information processing system of FIG. 1.

FIG. 2 shows the hardware arrangement of an information processing apparatus which serves as the information contents converter 101 and access controller 104 and its peripheral devices. Referring to FIG. 2, reference numeral 215 denotes an information processing apparatus which is implemented by, for example, a generally prevalent personal computer.

The information processing apparatus 215 can store digital data that configure information contents in an HD, CD, FD, DVD, and the like, and can display the stored digital data on a monitor 214. Furthermore, the apparatus 215 can transmit and receive digital data via the Internet or the like using an NIC 213 and the like.

The user inputs various instructions and the like via a mouse 211 and keyboard 212. Inside the information processing apparatus 215, respective blocks to be described below are connected via a bus 201 to be able to exchange various digital data. The respective blocks which configure the information processing apparatus 215 will be described below.

Reference numeral 214 denotes a monitor which displays various kinds of information in the information processing apparatus 215. Reference numeral 202 denotes a CPU which controls the operations of the respective units in the information processing apparatus 215 or executes control programs loaded onto a RAM 204.

Reference numeral 203 denotes a ROM which stores a BIOS and boot program. Reference numeral 204 denotes a RAM which temporarily stores control programs required to execute the processes by the CPU 202, and digital data to be processed. In the RAM 204, an OS, control programs required to implement the information processing method according to this embodiment, and the like are loaded.

Reference numeral 205 denotes a hard disk (HD) drive used to computer-readably store the OS and control programs to be transferred to the RAM 204 and the like, and to store and read out digital data during the operation of the apparatus.

Reference numeral 206 denotes a CD-ROM drive which allows to load digital data stored in a CD-ROM (CD-R) as one of external storage media or to write data in a CD-R. Reference numeral 207 denotes an FD (Floppy® disk) drive which allows loading data from an FD and to write data in the FD as in the CD-ROM drive 206. Reference numeral 208 denotes a DVD-ROM (DVD-RAM) drive which allows loading data from a DVD-ROM and to write data in a DVD-RAM as in the CD-ROM drive 206. When the control programs required to implement the information processing method according to this embodiment are stored in a CD-ROM, FD, DVD-ROM, and the like, these control programs are installed in the HD drive 205 and are transferred to the RAM 204 as needed.

Reference numeral 210 denotes an interface (I/F) which connects the information processing apparatus 215 to various peripheral devices. The mouse 211 and keyboard 212 are connected to the information processing apparatus 215 via the I/F 210, and various instructions input from the mouse 211 and keyboard 212 are input to the CPU 202 via the I/F 210.

Reference numeral 209 denotes an ASIC required to process digital data to be processed by the information processing apparatus 215 at high speed in place of the CPU 202. The ASIC 209 processes at high speed, for example, the encryption process and RIP process to be processed by the CPU 202 in place of the CPU 202.

Note that the hardware arrangement of an information processing apparatus used to implement the functions of the outsourcing destination is basically the same as that described above, and a repetitive description thereof will be avoided.

### 3. Digital Data to be Processed by Respective Units of Information Processing System

An overview of digital data to be processed by the respective units of the information processing system according to this embodiment will be described below.

(1) Information Contents 106

The information contents 106 correspond to a digital data group including digital data such as text data, image data, video data, and the like, which are required to output the output contents 112 to be described later.

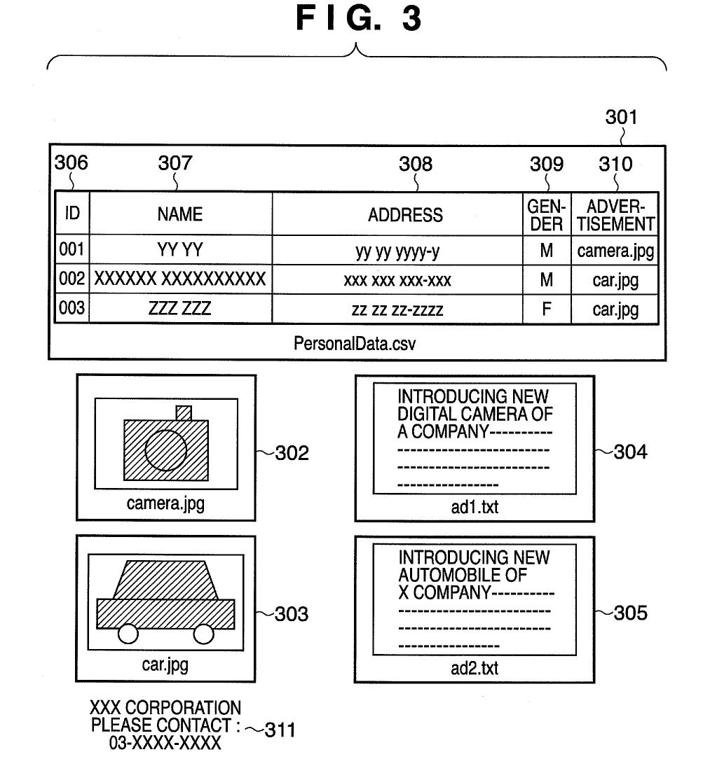

FIG. 3 shows an example of the information contents 106. Referring to FIG. 3, reference numeral 301 denotes personal information data which includes personal information and information associated with that person as a list. The personal information data 301 includes at least “personal name” 307 and “address” 308 to be output as the output contents 112 by the outsourcing destination. The personal information data 301 may further include “ID number” 306 required to specify a person, “gender” 309 of the person, and information (“advertisement” in this example) 310 that designates digital data to be embedded in the output contents 112 addressed to that person.

Reference numerals 302 and 303 denote image data; and 304, 305, and 311, text data. These data are used to generate the output contents 112.

(2) Output Information Contents 107

The output information contents 107 correspond to a digital data group which is used to generate the output contents data 111 in the output data embedding unit 103, and is laid out as objects described by the layout data 109.

For example, when the output contents 112 are output as a printed material, image data and text data such as text or the like, which are actually printed on the printed material configure the output information contents 107. Note that the output information contents 107 are generated by the information contents converter 101 based on the information contents 106.

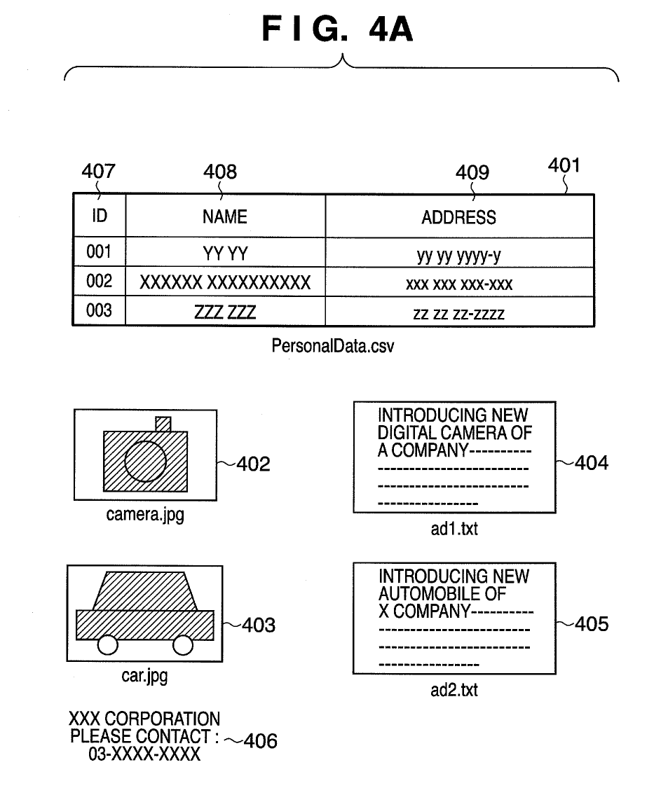

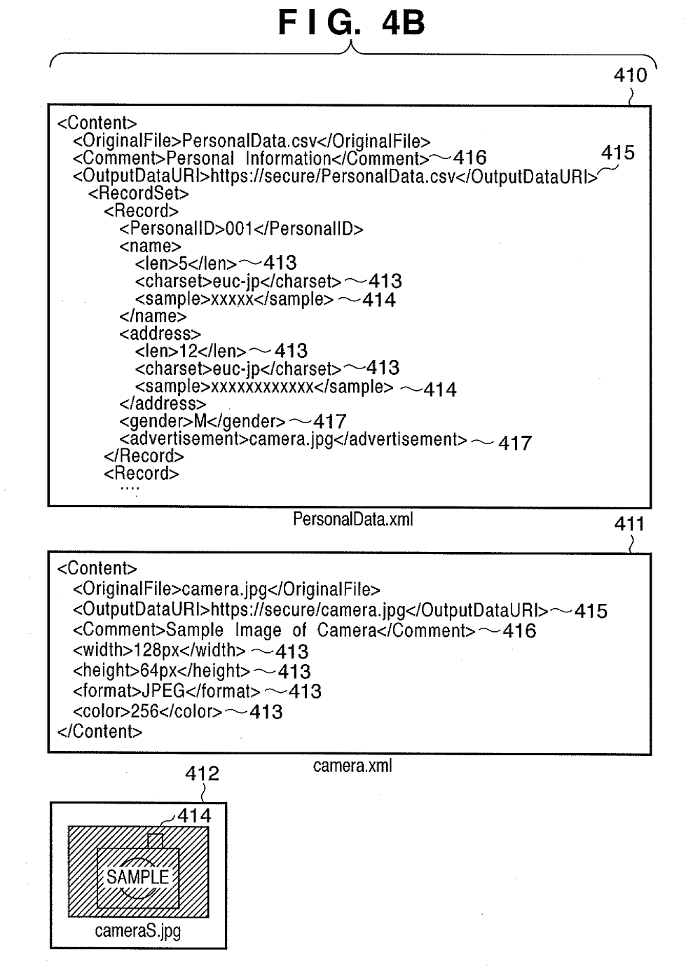

FIG. 4A shows an example of the output information contents 107 generated based on the information contents 106 shown in FIG. 3.

Referring to FIG. 4A, reference numeral 401 denotes digital data generated from the personal information data 301 as a list associated with personal information in the information contents 106. More specifically, the digital data 401 includes a list that collects information (ID 407 and name 408) to be output as the output contents 112, and data (address 409) required to specify information from that list.

Reference numerals 402, 403, 404, 405, and 406 denote digital data included in the information contents 106. If the detailed configuration of the output contents 112 is not determined at the time of generation of the output information contents 107 by the information contents converter 101, all digital data included in the information contents 106 may be used as those of the output information contents 107.

Note that the following description will be given under the assumption that the file format of the output information contents 107 is the same as that of the information contents 106. More specifically, the output information contents need only have a data format that can be processed by the output data embedding unit 103. For example, the digital data 401 may be described in an XML format or the digital data 402 and 403 may be converted into PostScript data.

(3) Layout Information Contents 108

The layout information contents 108 correspond to a digital data group used to generate the layout data 109 by the layout data generator 102. The layout information contents 108 are generated by the information contents converter 101 based on the information contents 106.

More specifically, the layout information contents 108 includes at least one or more pieces of layout attribute information to be exemplified below. With this information, upon generating the layout information at the outsourcing destination, a designer can examine the layout process without leaking any confidential information.

i) An example of the layout information contents when the information contents 106 correspond to text data

the number of characters that configure text data

information indicating whether text data include 2- or 1-byte characters

information indicating the context of text data.

ii) An example of the layout information contents when the information contents 106 correspond to image data

the width and/or height (size) of image data

information that expresses tint of image data such as reddish, bluish, and the like

image data obtained by converting original image data into low-resolution data

image data obtained by embedding a (visible or invisible) watermark in image data

information that image data expresses (designation of a portrait, landscape photo, and the like)

dummy (alternative) image data of image data

information indicating an encoding method of image data

For example, when the information contents correspond to text data like [YYYY City, XX Prefecture], an example of the layout information contents includes [“prefecture”, 13 1-byte characters], [“city”, 9 1-byte characters].

Also, when the information contents correspond to text data that expresses a name like [Ichiro Suzuki], the layout information contents include [“last name”, 6 characters] and [“first name”, 6 characters]. Note that information that expresses the contents of text data such as “prefecture”, “city”, “last name”, or “first name” is an example of the context of the text data, and information such as “two characters” is an example of the number of characters.

on the other hand, when the information contents correspond to image data, meta data such as the width and/or height of image data and/or dummy image data described above can be used as the layout information contents 108.

When such layout information contents 108 are extracted from the information contents 106, and is disclosed to the designer at the outsourcing destination, the designer can lay out data included in the information contents 106 more naturally (in consideration of the design).

For example, by presenting the configuration (e.g., the context or the like) of data that configure the information contents, the designer can appropriately determine a break position of a character string. That is, when no information about the context is disclosed to the designer, for example, text “New York City” may be unnaturally laid out like “New Yo[break]rk City”. However, since information about the context is disclosed, the designer can lay out that text more naturally like “New York [break] City”.

On the other hand, when no information about the tint of image data is disclosed, the designer may set a background color (hard to see) disportionate to the tint of that image data. By contrast, when information about the tint is disclosed, the designer can examine a natural background color. Furthermore, using information of the number of characters and the image size (width and/or height), the designer can lay out data by assigning an area large enough to output the data that configure the information contents.

An example of the layout information contents 108 which are generated by the information contents converter 101 based on the information contents 106 shown in FIG. 3 will be described below with reference to FIG. 4B.

Referring to FIG. 4B, reference numeral 410 denotes layout information contents PersonalData.csv, which are indicated as the personal information data 301 in the information contents 106 and are described in XML. Reference numeral 411 denotes image data camera.jpg which is indicated as the image data 302 in the information contents 106 and is described in XML.

As the layout information contents 108 generated from the image data 302, sample digital data 412, that is, digital data as an alternative to original digital data may be used in place of the original digital data.

The digital data 410 and 411 in XML are configured by a plurality of tags. However, since the contents expressed by the respective tags are apparent from their names, a detailed description thereof will not be given. The format of the layout information contents 108 is not limited to XML, but the layout information contents 108 may be described in a text format or by binary data. Furthermore, items of data included in the layout information contents 108 are not limited to the aforementioned items.

Reference numeral 413 denotes meta information, that is, layout attribute information, of the information contents required to lay out the output information contents 107 to be output as the output contents 112. The layout attribute information includes the numbers of pixels of the width and height of the aforementioned information contents, the number of characters of text, encoding method, tint information, and the like.

Reference numeral 414 denotes information which is to be displayed as alternative contents when the access controller 104 denies loading of the output information contents 107 generated based on the information contents 106. For example, the alternative contents include data obtained by reducing the resolution or tint of the information contents or data obtained by embedding watermark characters in case of image data, or alternative character string data in case of text data.

Reference numeral 415 denotes a URI or the like required to access the output information contents 107 corresponding to the layout information contents 108. Reference numeral 416 denotes a comment that describes the contents of the information contents 106 as a generation source of the layout information contents 108. Reference numeral 417 denotes information used to determine objects that configure the output contents 112. For example, the information 417 is used to designate an advertisement image to be inserted for a certain person, or to change the color or design depending on the gender of that person.

(4) Layout Data 109

The layout data 109 is digital data which is required for the output data embedding unit 103 to generate the output contents data 111, and describes how to lay out objects. Note that the objects are handling units of digital data which configure the output contents 112. The digital data included in the output information contents 107 used to configure the output contents data 111 are laid out to have objects as units. The layout data 109 is generated by the information contents converter 101 using the layout information contents 108 generated based on the information contents 106.

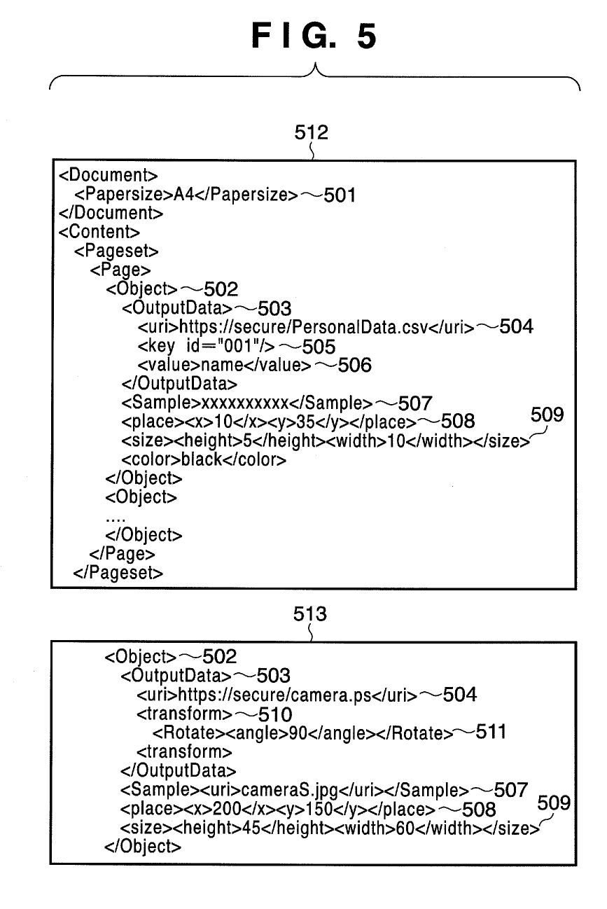

FIG. 5 shows an example of the layout data 109. Reference numeral 512 denotes an XML description of the layout data 109; and 513, a description example when an object is image data.

Referring to FIG. 5, reference numeral 501 denotes a tag used to describe information about the output contents 112 to be output using the layout data 109. For example, the tag 501 describes information including the paper size of a printed material, the resolution of a display used to output the contents 112, and the like.

Reference numeral 502 denotes a tag used to describe an object which configures the output contents. Reference numeral 503 denotes a tag used to describe information required to specify the output information contents. Reference numeral 504 denotes a tag used to describe a URI of the output information contents 107. When the output information contents 107 have a list format including a plurality of pieces of information, the output information contents 107 to be laid out as objects are designated further using tags 505 and 506.

Reference numeral 507 denotes a tag used to describe information required to display an alternative when the access-controlled output information contents 107 cannot be acquired. Reference numeral 508 denotes a tag used to indicate the layout coordinates of the object described using the tag 502 in a page. Reference numeral 509 denotes a tag used to describe the output size of the object described using the tag 502. Reference numeral 510 denotes a tag used when the output information contents 107 are to be laid out so that they are deformed and output. A tag 511 indicates that the contents 107 are output after rotation through 90°.

Note that the format of the layout data of the present invention is not limited to XML. That is, various other formats such as an HTML format, binary format, and the like can be applied as long as the output data embedding unit 103 can process these data formats.

(5) Output Contents Data 111

The output contents data 111 is data to be processed when the output unit 105 outputs the output contents 112, and is generated by the output data embedding unit 103. For example, when the output unit 105 comprises a printer, the output contents data 111 is PostScript or raster data to be processed by the printer, and the output contents 112 are printed materials. Alternatively, when the output unit 105 comprises a display, the output contents data 111 is bitmap data to be input to the display, and the output contents 112 are screen output to be displayed on the display.

(6) Output Contents 112

The output contents 112 correspond to contents to be output by the output unit 105 after a plurality of information contents 106 are laid out. For example, the output contents 112 are visually output contents such as a printed material output onto a paper medium, a screen output to be output to the display, and the like.

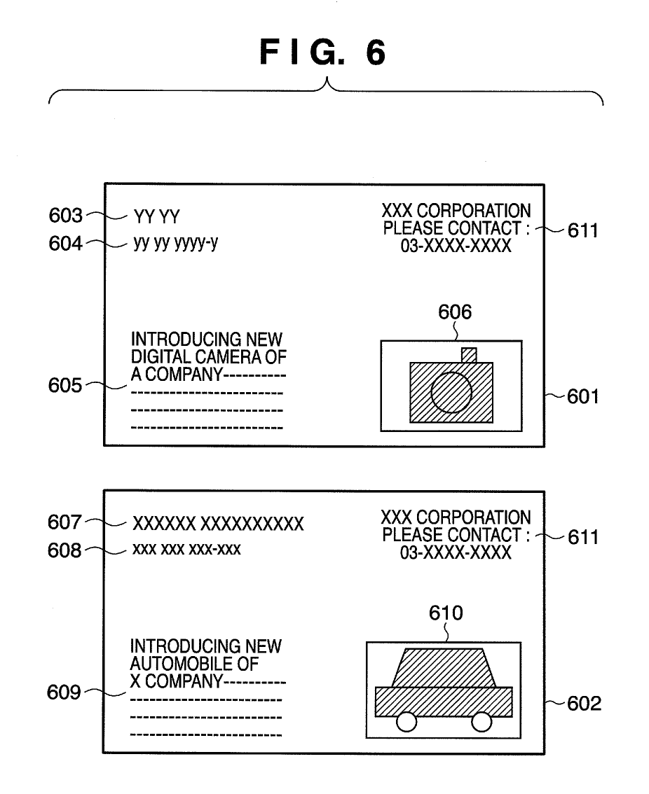

FIG. 6 shows examples of the output contents 112 generated using the information contents 106 shown in FIG. 3. In FIG. 6, reference numerals 601 and 602 denote examples of the output contents 112 to be output as printed materials or to the display. The output contents 601 and 602 are respectively configured by “personal names” 603 and 607, “personal addresses” 604 and 608, “advertisements” 605 and 609, image data 606 and 610, and information 611 of a source company. Note that the company information 611 is output as fixed data for all pages.

### 4. Detailed Arrangements of Respective Units that Configure Information Processing System

The arrangements of the respective units used to output the output contents as a printed material will be described in detail below. That is, the arrangements of the respective units upon outputting the output contents 112 exemplified in FIG. 6 as printed materials using the information contents 106 exemplified in FIG. 3 will be described in detail.

Note that the present invention is not limited to the output of printed materials, but it is applicable to cases in which the contents are to be output onto the screen or other output media.

(1) Detailed Arrangement and Processing Sequence of Information Contents Converter 101

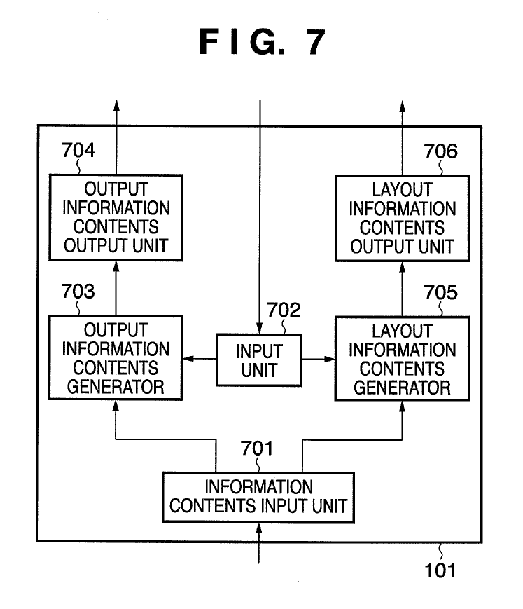

The detailed arrangement of the information contents converter 101 will be described first with reference to FIG. 7. FIG. 7 is a block diagram showing the internal arrangement of the information contents converter 101. As shown in FIG. 7, the information contents converter 101 comprises an information contents input unit 701, input unit 702, output information contents generator 703 and output unit 704, and layout information contents generator 705 and output unit 706.

The information contents input unit 701 externally loads the information contents 106. The input unit 702 inputs control information based on various user's instructions via the mouse 211 and keyboard 212.

The output information contents generator 703 inputs the control information input from the input unit 702 and the information contents 106 loaded by the information contents input unit 701, and generates the output information contents 107. The unit 703 outputs the generated output information contents 107 via the output information contents output unit 704.

Note that the control information input from the input unit 702 is used to set data of the output information contents 107 to be generated based on the information contents 106. The data setting designates, for example, the data and formats of the information contents 106 upon outputting as the output information contents 107. If data defined by the user in advance is available for settings based on various instructions input from the input unit 702, that data may be used as the input from the input unit 702.

The layout information contents generator 705 inputs the control information input from the input unit 702 and the information contents 106 loaded by the information contents input unit 701, and generates the layout information contents 108. The unit 705 outputs the generated layout information contents 108 via the layout information contents output unit 706.

Note that the control information input from the input unit 702 is used to set data of the layout information contents 108 to be generated based on the information contents 106. The data setting designates, for example, the data and formats of the information contents 106 upon outputting as the layout information contents 108.

Note that the information contents input unit 701, output information contents output unit 704, and layout information contents output unit 706 can exchange digital data with external components. The digital data in this case include those of a network interface such as the NIC 213 or the like, input/output devices of media represented by a CD, FD, and DVD, and the inter-process communication process in the computer.

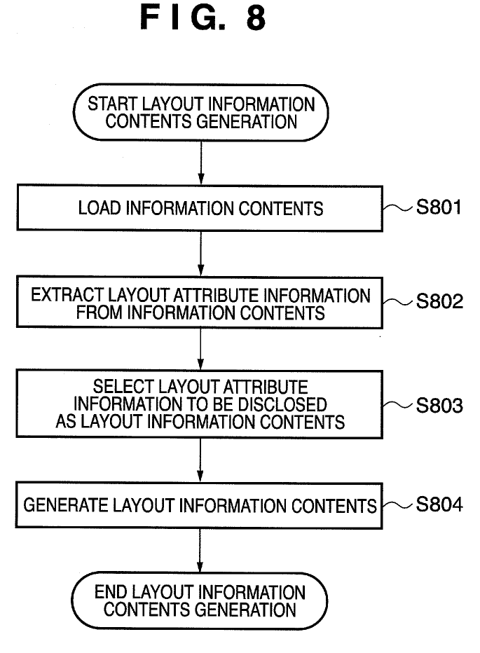

The sequence of the layout information contents generation process of the processes to be executed by the information contents converter 101 will be described below with reference to FIG. 8. In step S801, the information contents input unit 701 loads information contents.

Subsequently, in step S802 the information contents input unit 701 transmits the information contents to the layout information contents generator 705, which extracts the aforementioned layout attribute information.

For example, when the information contents correspond to text data, since the text data does not include any information such as the number of characters, context, and the like, the layout information contents generator 705 calculates (extracts) layout attribute information from the input text data. That is, the layout information contents generator 705 extracts the layout attribute information by calculating the number of characters of the text data if the layout attribute information is the number of characters, and parsing if it is the context.

On the other hand, when the information contents correspond to image data, the layout information contents generator 705 calculates tint information by executing the statistical process of color information for respective pixels of the image data. Or when the information contents describe in advance information such as the width and/or height of an image (for example, when such information is described in the header of the image), the unit 705 can read that information and can set (copy) it as the layout attribute information.

Furthermore, the user may generate layout attribute information by operating a text editor or image edit software, or may modify (edit) the extracted (calculated or copied) layout attribute information. Alternatively, the user may select image data generated in advance or the like (as dummy data).

In step S803, information to be disclosed to the designer as the layout information contents of the layout attribute information extracted by the layout information contents generator 705 is selected via the input unit 702. Note that the layout attribute information to be disclosed may be automatically selected according to the data items of the layout attribute information, which are set in advance, or the user may select the layout attribute information to be disclosed to the designer. In the latter case, for example, the user selects information from a plurality of dummy data presented by the information contents converter 101.

In step S804, the layout information contents generator 705 generates the layout information contents based on the selected layout attribute information.

(2) Processing in Access Controller 104

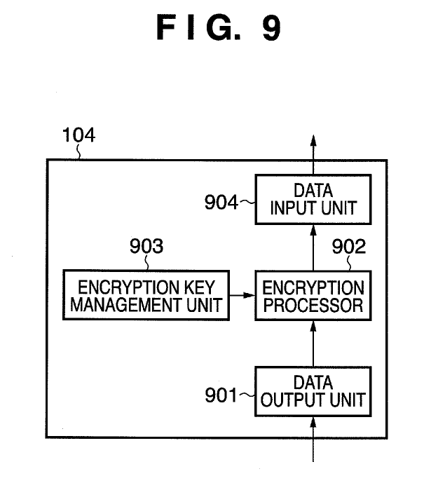

The processing in the access controller 104 will be described below with reference to FIG. 9. FIG. 9 is a block diagram showing the internal arrangement of the access controller 104. As shown in FIG. 9, the access controller 104 comprises a data input unit 901, encryption processor 902, encryption key management unit 903, and data output unit 904. The access controller 104 controls to allow only the output data embedding unit 103 and entity such as a device, person, or the like authorized by the outsourcer to read out the output information contents 107 generated by the information contents converter 101.

The data input unit 901 loads the output information contents 107 generated by the information contents converter 101. The encryption processor 902 executes an encryption process by inputting an encryption key managed by the encryption key management unit 903 and the output information contents 107 loaded by the data input unit 901, thus generating encrypted output information contents 110.

The encryption key management unit 903 manages the encryption key used in the encryption process of the output information contents 107 so as not to be illicitly accessed. The data output unit 904 externally outputs the encrypted output information contents 110 generated by the encryption processor 902.

Note that the data input unit 901 and data output unit 904 can exchange digital data with external components. The digital data in this case include those of a network interface such as the NIC 213 or the like, input/output devices of media represented by a CD, FD, and DVD, and the inter-process communication process in the computer. The encryption key management unit 903 is implemented on a storage device such as the HD drive 205 and RAM 204.

(3) Detailed Arrangement of Layout Data Generator 102

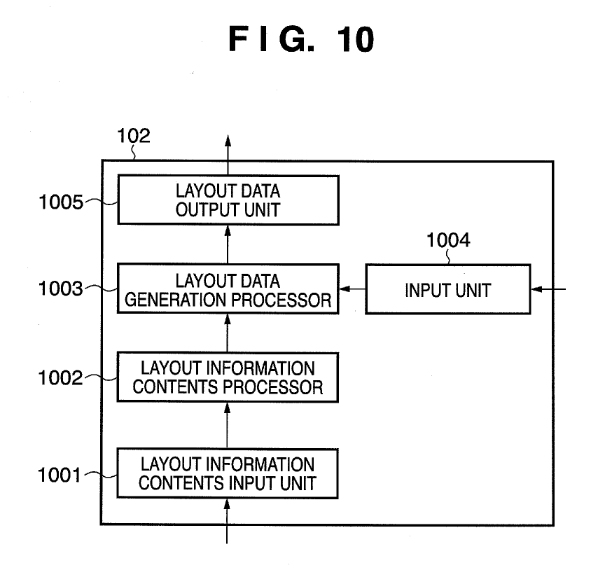

The detailed arrangement of the layout data generator 102 will be described below with reference to FIG. 10. FIG. 10 is a block diagram showing the internal arrangement of the layout data generator 102. As shown in FIG. 10, the layout data generator 102 comprises a layout information contents input unit 1001, layout information contents processor 1002, layout data generation processor 1003, input unit 1004, and layout data output unit 1005.

The layout information contents input unit 1001 loads the layout information contents 108 generated by the information contents converter 101. The layout information contents processor 1002 reads out data items described in the layout information contents 108.

The layout data generation processor 1003 generates the layout data 109 using the data items of the layout information contents 108 read out by the layout information contents processor 1002 and control information input from the input unit 1004.

Note that the control information input from the input unit 1004 is based on various user's instructions input via the mouse 211 and keyboard 212. More specifically, the control information designates the layout of objects which configure the output contents 112 using various digital data described in the layout information contents 108.

For example, the control information designates the layout of the output information contents 107 that configure the output contents 112 with reference to the information 413 such as the width, height, and the like, and the sample data 414 of the output information contents 107.

The layout data generation processor 1003 may visualize the layout information contents shown in FIG. 4B (in place of XML text) and may present it to the designer. For example, the processor 1003 may present, to the designer, an alternative character string “*****” in place of [text of five 1-byte characters]. Alternatively, the processor 1003 may present an alternative character string “**** City, ** Prefecture” in place of [“prefecture”, 13 1-byte characters], [“city”, 9 1-byte characters]

The layout data output unit 1005 outputs the layout data 109 generated by the layout data generation processor 1003. Note that the layout data output unit 1005 can exchange digital data with external components. The digital data in this case include those of a network interface such as the NIC 213 or the like, input/output devices of media represented by a CD, FD, and DVD, and the inter-process communication process in the computer.

(4) Detailed Arrangement of Output Data Embedding Unit 103

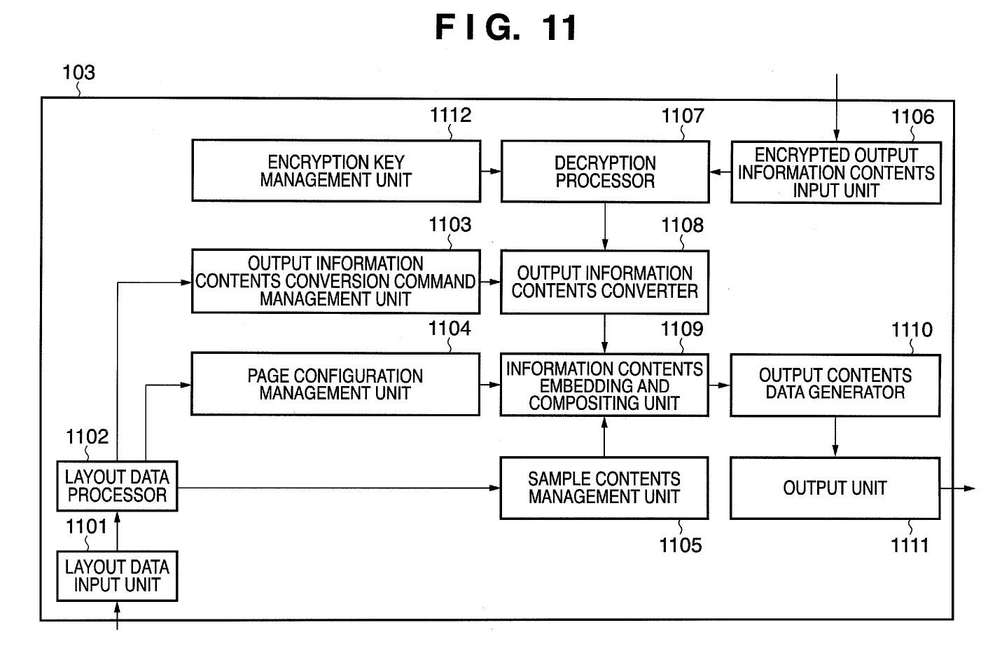

The processing in the output data embedding unit 103 will be described below with reference to FIG. 11. FIG. 11 is a block diagram showing the internal arrangement of the output data embedding unit 103, and the output data embedding unit 103 comprises the following components.

That is, the output data embedding unit 103 includes a layout data input unit 1101, layout data processor 1102, output information contents conversion command management unit 1103, page configuration management unit 1104, and sample contents management unit 1105. Furthermore, the unit 103 includes an encrypted output information contents input unit 1106, decryption processor 1107, output information contents converter 1108, information contents embedding and compositing unit 1109, output contents data generator 1110, output unit 1111, and decryption key management unit 1112.

The output data embedding unit 103 inputs the layout data 109 and output information contents 107, and outputs the output contents data 111.

The layout data input unit 1101 loads the layout data 109 generated by the layout data generator 102. The layout data processor 1102 stores information described in the layout data 109 in the output information contents conversion command management unit 1103, page configuration management unit 1104, and sample contents management unit 1105.

Note that the data to be managed by the output information contents conversion command management unit 1103 is object conversion information, which is designated by the tag 510 in FIG. 5 as an example of the layout data 109.

Also, the page configuration management data to be managed by the page configuration management unit 1104 includes information indicating the page size, and the positions of objects laid out within a page, which are described by, for example, the tags 501, 508, and 509 in FIG. 5.

Furthermore, the information to be managed by the sample contents management unit 1105 is sample data which is described by, for example, the tag 508 in FIG. 5, and is to be output as an alternative when the output information contents 107 cannot be acquired. In addition, it is effective to hold preview data to be preview-displayed as sample data.

The encrypted output information contents input unit 1106 loads the encrypted output information contents 110. The decryption processor 1107 decrypts the encrypted output information contents 110 loaded by the encrypted output information contents input unit 1106 using a decryption key managed by the decryption key management unit 1112, thus obtaining the output information contents 107.

The decryption key management unit 1112 manages the decryption key used to decrypt the output information contents encrypted by the encryption processor 902 in the access controller 104. Note that the decryption key managed by the decryption key management unit 1112 is securely given in a predetermined sequence.

The decryption key management unit 1112 may pass the decryption key to the decryption processor 1107 only when a condition designated in advance is satisfied. The condition includes, for example, the user who accesses the output information contents 107, the access type such as full access, partial access, edit, and the like to the output information contents 107, and the like. Also, the condition may include a decryption permission period of the output information contents 107, the number of times of permission of decryption, the number of output pages of the printed material, and the like.

The output information contents converter 1108 converts the output information contents 107 decrypted by the decryption processor 1107 in accordance with the data managed by the output information contents conversion command management unit 1103. The information contents embedding and compositing unit 1109 lays out and composites the output information contents 107 converted by the output information contents converter 1108 using the data managed by the page configuration management unit 1104.

When the output information contents 107 cannot be acquired for a reason such as a decryption failure in the decryption processor 1107 or the like, the sample data managed by the sample contents management unit 1105 may be embedded in place of the output information contents 107.

The output contents data generator 1110 generates the output contents data 111 using the data generated by the information contents embedding and compositing unit 1109. The output unit 1111 externally outputs the generated output contents data 111.

Note that the output information contents conversion command management unit 1103, page configuration management unit 1104, and sample contents management unit 1105 are implemented on a storage device represented by the HD drive 205 and RAM 204.

The output unit 1111 can exchange digital data with external components. The digital data in this case include those of a network interface such as the NIC 213 or the like, input/output devices of media represented by a CD, FD, and DVD, and the inter-process communication process in the computer. Also, the digital data include those of an interface to a printer or display.

The processes of the respective units to be executed from when the output information contents 107 and layout information contents 108 are extracted based on the information contents 106 shown in FIG. 1 until the output contents 112 are finally output in this embodiment have been described. Practical examples in which the information processing system according to this embodiment is applied to actual print operations will be described below.

### 5. Example 1

A case will be explained first wherein a company (outsourcer) having information contents 106 outsources the layout process to a layout contractor as an outsourcing destination, and outsources the print process for outputting the information contents that have undergone the layout process as printed materials to a print contractor.

5.1 Information Processing System

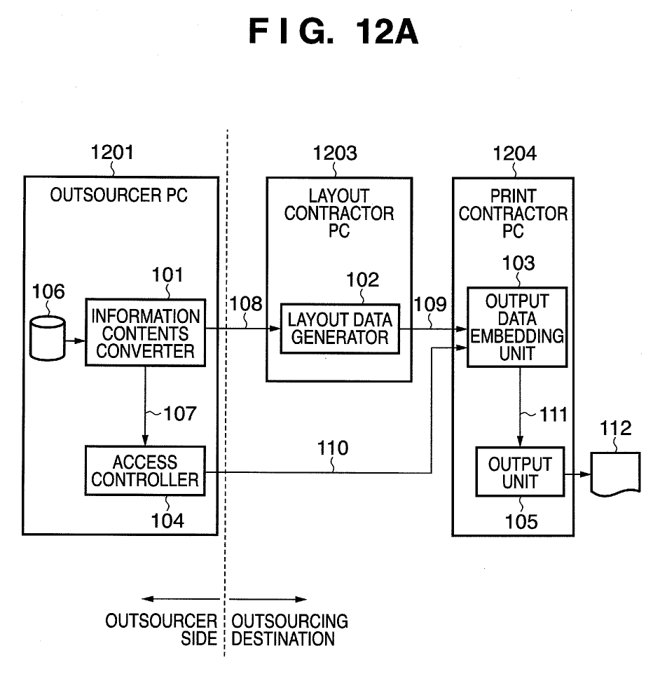

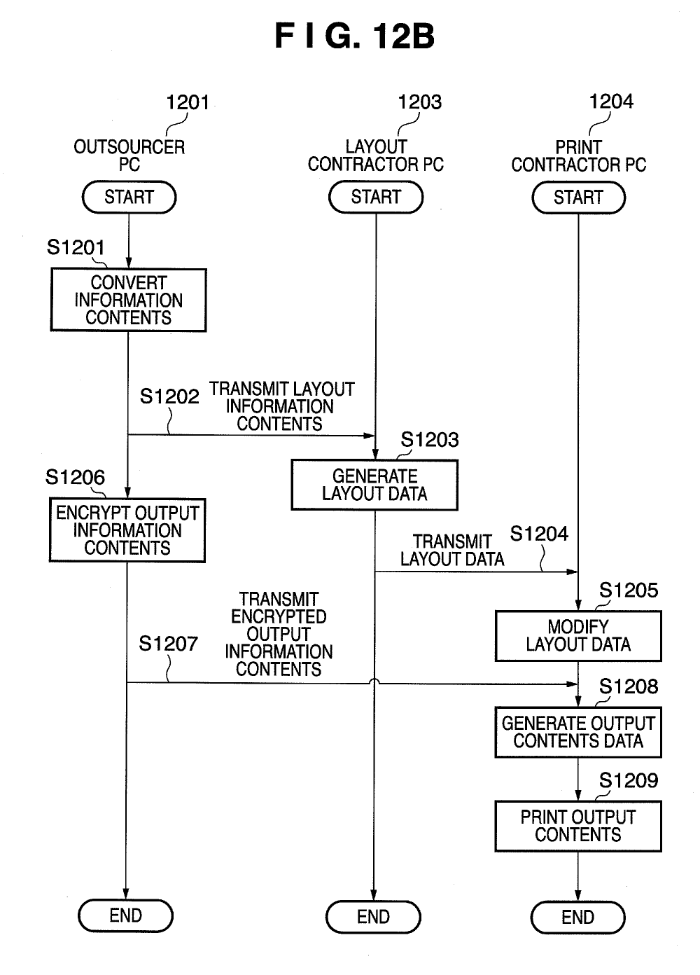

FIG. 12A shows an example of the arrangement of an information processing system in which the outsourcer respectively outsources the layout process and print process to a layout contractor and print contractor as outsourcing destinations.

As shown in FIG. 12A, an outsourcer PC 1201 (first information processing apparatus), layout contractor PC 1203 (second information processing apparatus), and print contractor PC 1204 (third information processing apparatus) are connected to be able to communicate with each other.

The outsourcer PC 1201 comprises the information contents converter 101 and access controller 104 shown in FIG. 1. The layout contractor PC 1203 comprises the layout data generator 102, and the print contractor PC 1204 comprises the output data embedding unit 103 and output unit 105.

With this arrangement, the information contents 106 in the outsourcer PC 1201 are finally output from the print contractor PC 1204 as output contents 112. Note that the data transmitted from the respective units shown in FIG. 12A have already been explained, and a detailed description thereof will not be given.

5.2 Sequence of Processes

FIG. 12B is a flowchart showing the sequence of the processes in the information processing system shown in FIG. 12A. FIG. 12B shows the sequence when the outsourcer PC 1201 asks the layout contractor for the layout process of the information contents 106, and the print contractor PC 1204 outputs printed materials using the layout data obtained as a result of the layout process.

In step S1201, the information contents converter 101 of the outsourcer PC 1201 executes processing to generate the output information contents 107 and layout information contents 108. In step S1202, the outsourcer PC 1201 transmits the layout information contents 108 to the layout contractor (first transmission unit).

On the other hand, as for the output information contents 107 generated in step S1201, the access controller 104 executes processing in step S1206 to generate the encrypted output information contents 110. In step S1207, the outsourcer PC 1201 transmits the generated encrypted output information contents 110 to the print contractor PC 1204 (second transmission unit).

Upon reception of the layout information contents 108, the layout contractor PC 1203 executes the processing of the layout data generator 102 in step S1203 to generate layout data 109. After that, the layout contractor PC 1203 transmits the layout data 109 to the print contractor PC 1204 in step S1204 (third transmission unit).

The print contractor PC 1204 modifies the layout data 109 received from the layout contractor PC 1203 as needed (step S1205).

The output data embedding unit 103 processes the layout data 109 and encrypted output information contents 110 to generate output contents data 111 (step S1208).

Finally, the printer as the output unit 105 processes the output contents data 111 to output output contents 112 as printed materials (step S1209).

As described above, according to this embodiment, since the output information contents are encrypted for the purpose of access control, leakage of confidential data can be prevented. In addition, the layout process can be executed using the layout information contents to generate output contents data. That is, the layout process can be freely executed using the layout information contents 108 without disclosing the contents of the information contents 106 such as personal information and the like to the print contractor and design company, and the output contents data 111 can be finally output.

### 6. Example 2

A case will be explained below wherein a company (outsourcer) having information contents 106 outsources the layout process and print process to a print contractor as an outsourcing destination.

6.1 Information Processing System

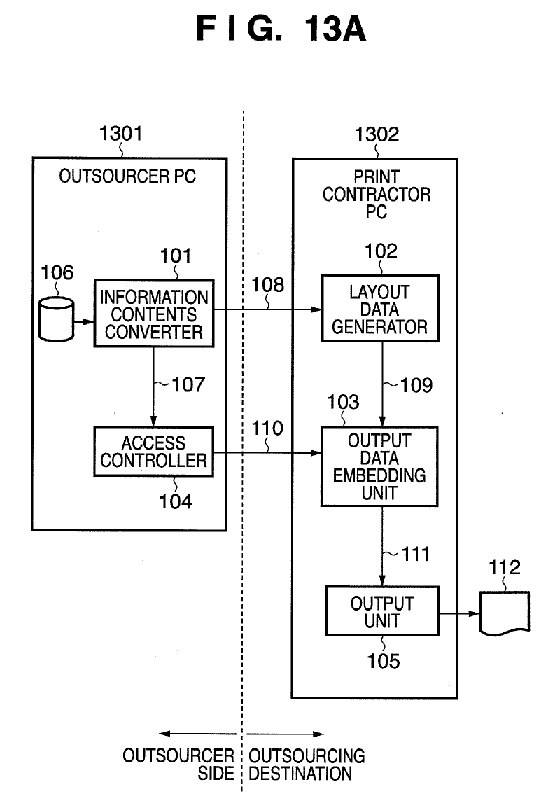

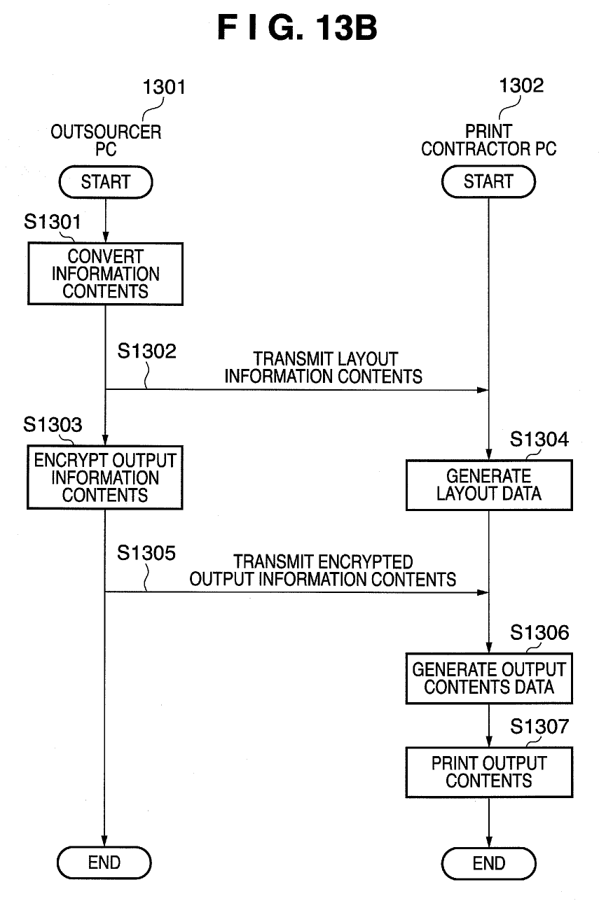

FIG. 13A shows an example of an information processing system when the outsourcer outsources the layout process and print process to a print contractor as an outsourcing destination.

As shown in FIG. 13A, an outsourcer PC 1301 and print contractor PC 1302 are connected to be able to communicate with each other.

The outsourcer PC 1301 comprises the information contents converter 101 and access controller 104 shown in FIG. 1, and the print contractor PC 1302 comprises the layout data generator 102, output data embedding unit 103, and output unit 105.

With this arrangement, the information contents 106 in the outsourcer PC 1301 are finally output from the print contractor PC 1302 as the output contents 112. Note that the data transmitted from the respective units shown in FIG. 13A have already been explained, and a detailed description thereof will not be given.

6.2 Sequence of Processes

FIG. 13B is a flowchart showing the sequence of the processes in the information processing system shown in FIG. 13A. FIG. 13B shows the sequence from when the outsourcer PC 1301 converts the information contents 106 until the print contractor PC 1302 outputs printed materials (output contents 112).

The information contents converter 101 of the outsourcer PC 1301 executes processing to generate output information contents 107 and layout information contents 108 (step S1301). The outsourcer PC 1301 transmits the layout information contents 108 to the print contractor PC 1302 (step S1302).

The print contractor PC 1302 executes the processing of the layout data generator 102 to generate layout data 109 (step S1304).

In the outsourcer PC 1301, the access controller 104 processes the output information contents 107 to generate encrypted output information contents 110 (step S1303), and transmits it to the print contractor PC 1302 (step S1305).

The print contractor PC 1302 executes the processing of the output data embedding unit 103 to process the encrypted output information contents 110 and layout data 109, thus generating output contents data 111 (step S1306).

Finally, in the print contractor PC 1302, the printer as the output unit 105 processes the output contents data 111, thus outputting output contents 112 as printed materials (step S1307).

Note that the encryption key used in the encryption process in step S1303 is that which can be decrypted by the output data embedding unit 103, and the output data embedding unit 103 has a tamper resistance. Therefore, the encrypted output information contents 110 of this embodiment can be kept secret from the print contractor. Note that the processing of the access controller 104 (step S1303) may be executed before the transmission timing of the layout information contents 108 to the print contractor (step S1302).

As described above, according to this embodiment, since the output information contents are encrypted for the purpose of access control, leakage of confidential data can be prevented. In addition, the layout process can be executed using the layout information contents to generate output contents data. That is, the layout process can be freely executed using the layout information contents 108 without disclosing the contents of the information contents 106 such as personal information and the like to the print contractor, and the output contents data 111 can be finally output.

### Second Embodiment

In the example described in the first embodiment, the access controller 104 executes only the encryption process of the output information contents 107 to output the encrypted output information contents 110. However, the function of the access controller of the information processing system of the present invention is not limited to this. For example, a function of a server having an access authentication function may be provided to the access controller 104. For example, the access controller 104 may serve as a server which authenticates an entity using an ID and password, or biological information, and delivers data to only an authentic entity.

In the example described in the first embodiment, the encrypted output information contents 110 are processed by the output data embedding unit 103 together with the layout data 109. However, the output destination of the encrypted output information contents 110 of the information processing system of this embodiment is not limited to this. For example, the layout data generator 102 may process the encrypted output information contents 110 and layout information contents 108 to generate the layout data 109. In this case, the encrypted output information contents 110 are used as internal data of the layout data 109 intact. The output data embedding unit 103 can decrypt the encrypted output information contents 110 without inputting the contents 110 and can generate the output information contents 107.

### Third Embodiment

In the description of the first embodiment, the layout data 109 is generated from the layout information contents 108. However, the present invention is not limited to this. For example, a template of a printed material may be prepared using dummy data, and the layout data 109 may be generated using that template and the layout information contents 108.

For example, the dummy data is text data as an alternative to the contents of the information contents like “Ichiro Suzuki” in case of the information of the “name” 408 in the PersonalData.csv 401.

On the other hand, in case of an image to be embedded as an advertisement like the image data 302 (camera.jpg), image data that merely displays a plain image may be used. Furthermore, the dummy data of the “name” 408 is preferably appended with information indicating that “the name included in the information contents 106 has a maximum of 20 characters”. Likewise, the dummy data of the image data 302 (camera.jpg) is desirably appended with information that expresses the feature of the information contents 106 like “the image of an advertisement has X pixels (vertical) and Y pixels (horizontal)”.

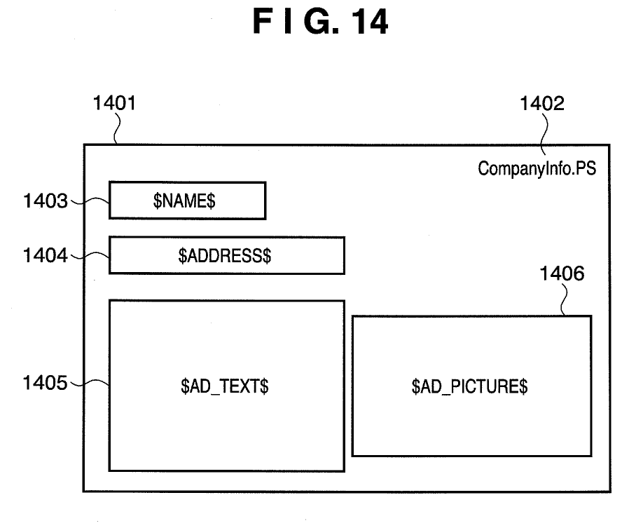

An example of the template will be described below with reference to FIG. 14. Reference numeral 1401 denotes a template which can be used to generate a printed material shown in FIG. 6. Template data describes a variable data part for each page using variables and the coordinates and sizes of areas to which the variables are output, as denoted by reference numerals 1403 to 1406. Also, an identifier of information used as fixed data for respective pages may be described, as denoted by reference numeral 1402.

The layout data 109 shown in FIG. 5 is generated in such a manner that the layout information contents 108 are substituted into areas described as variables of the template. Before substitution of the layout information contents 108 into the variables described on the template, the sizes of the areas may be adjusted using the layout attribute information such as the character string lengths, sizes, and the like of the layout information contents 108. As for the process for printing the layout data 109, since the already explained method is applicable, a repetitive description thereof will be avoided.

### Other Embodiments

Note that the present invention may be applied to either a system constituted by a plurality of devices (e.g., a host computer, interface device, reader, printer, and the like), or an apparatus consisting of a single device (e.g., a copying machine, facsimile apparatus, or the like).

The objects of the present invention can be achieved by supplying a recording medium, which records a program code of software that can implement the functions of the aforementioned embodiments, to the system or apparatus. In this case, the functions are implemented when a computer (or a CPU or MPU) of the system or apparatus reads out and executes the program code stored in the recording medium. Note that, in such case, the recording medium which stores the program code constitutes the present invention.

As the recording medium used to supply the program code, for example, a Floppy® disk, hard disk, optical disk, magneto-optical disk, CD-ROM, CD-R, magnetic tape, nonvolatile memory card, ROM, and the like can be used.

The functions of the aforementioned embodiments can be implemented not only when the computer executes the readout program code but also by the following case. For example, an OS (operating system) or the like which runs on the computer executes some or all of actual processing operations based on instructions of the program code to implement the functions of the aforementioned embodiments.

Furthermore, the present invention also includes the following case. That is, the program code read out from the recording medium is written in a memory equipped on a function expansion board or function expansion unit, which is inserted into or connected to the computer. That is, after the program code is written in the memory, a CPU or the like equipped on the function expansion board or unit executes some or all of actual processing operations based on instructions of the program code to implement the functions of the aforementioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2006-322521 filed on Nov. 29, 2006, and No. 2007-259236 filed on Oct. 2, 2007, which are hereby incorporated by reference herein in their entirety.

What is claimed is:

1. An information processing system which lays out data included in information contents and visually outputs the laid-out data by connecting a plurality of information processing apparatuses to be able to communicate with each other,
a first information processing apparatus comprising:
a conversion unit configured to convert the data to be laid out and visually output into information indicating an attribute of the data;
an encryption unit configured to encrypt the data to be laid out and visually output; and
a transmission unit configured to transmit the information to a second information processing apparatus, and to transmit the data encrypted by said encryption unit to a third information processing apparatus,
the second information processing apparatus comprising:
a generation unit configured to generate layout data used to lay out the data based on the information transmitted by said transmission unit in the first information transmission apparatus; and
a transmission unit configured to transmit the layout data generated by said generation unit to the third information processing apparatus, and
the third information processing apparatus comprising:
a decryption unit configured to decrypt the data transmitted by said transmission unit in the first information processing apparatus; and
an output unit configured to lay out the data decrypted by said decryption unit based on the layout data transmitted by said transmission unit in the second information processing apparatus, and to visually output the laid-out data.

2. The system according to claim 1, wherein when the data is text data, said conversion unit converts the text data into one of the number of characters which configure the text data, information indicating whether the text data includes 2-byte characters or 1-byte characters, and information indicating a context of the text data.

3. The system according to claim 1, wherein when the data is image data, said conversion unit converts the image data into one of a size of the image data, information indicating a tint of the image data, image data obtained by the image data into low-resolution data, image data obtained by embedding a watermark in the image data, information indicating contents of the image data, dummy image data of the image data, and information indicating an encoding method of the image data.

4. An information processing apparatus comprising:
a conversion unit configured to convert data to be laid out and visually output into information indicating an attribute of the data;
an encryption unit configured to encrypt the data to be laid out and visually output; and
a transmission unit configured to transmit the information to an information processing apparatus which executes a layout process based on the information and outputs layout data, and to transmit the data encrypted by said encryption unit to an information processing apparatus which can decrypt the data, and can lay out and visually output the decrypted data based on the layout data.

5. The apparatus according to claim 4, wherein when the data is text data, said conversion unit converts the text data into one of the number of characters which configure the text data, information indicating whether the text data includes 2-byte characters or 1-byte characters, and information indicating a context of the text data.

6. The apparatus according to claim 4, wherein when the data is image data, said conversion unit converts the image data into one of a size of the image data, information indicating a tint of the image data, image data obtained by the image data into low-resolution data, image data obtained by embedding a watermark in the image data, information indicating contents of the image data, dummy image data of the image data, and information indicating an encoding method of the image data.

7. An information processing method comprising:
a conversion step of converting data to be laid out and visually outputting into information indicating an attribute of the data;
an encryption step of encrypting the data to be laid out and visually output;
a first transmission step of transmitting the information to an information processing apparatus which executes a layout process based on the information and outputs layout data; and
a second transmission step of transmitting the data encrypted in the encryption step to an information processing apparatus which can decrypt the data, and can lay out and visually output the decrypted data based on the layout data.

8. The method according to claim 7, wherein when the data is text data, the conversion step converts the text data into one of the number of characters which configure the text data, information indicating whether the text data includes 2-byte characters or 1-byte characters, and information indicating a context of the text data.

9. The method according to claim 7, wherein when the data is image data, the conversion step converts the image data into one of a size of the image data, information indicating a tint of the image data, image data obtained by the image data into low-resolution data, image data obtained by embedding a watermark in the image data, information indicating contents of the image data, dummy image data of the image data, and information indicating an encoding method of the image data.

10. A computer-readable storage medium storing a control program for making a computer execute an information processing method according to claim 7.
